(19) United States
(12) Patent Application Publication
(10) Pub. No.: US 2014/0208305 A1
(43) Pub. Date: Jul. 24, 2014

(54) Automatically Identifying Criticality of Software Fixes Specific to a Client Deployment and Usage of Software Product

(71) Applicant: INTERNATIONAL BUSINESS MACHINES CORPORATION, Armonk, NY (US)

(72) Inventors: Salil Ahuja, Austin, TX (US); Amod V. Bhise, Round Rock, TX (US); Pankuj Chachra, Austin, TX (US)

(73) Assignee: International Business Machines Corporation, Armonk, NY (US)

(21) Appl. No.: 13/747,627

(22) Filed: Jan. 23, 2013

(51) Int. Cl. G06F 9/445

(52) U.S. Cl. CPC G06F 8/65
USPC 717/171

(57) ABSTRACT

A mechanism is provided in a data processing system for identifying criticality of a software fix. The mechanism obtains a criticality description associated with a software fix of a software product deployed on the data processing system. The mechanism determines a criticality value of the software fix based on computing environment of the data processing system and customer usage of the software product on the data processing system.

### BACKGROUND

The present application relates generally to an improved data processing apparatus and method and more specifically to mechanisms for automatically identifying criticality of software fixes specific to a client deployment and usage of a software product.

Software products require regular upkeep and fixes. A significant portion of information technology (IT) budgets go toward upkeep of software, maintenance, and updates. It is not uncommon that even though fixes exist, they have not been applied to a system and, therefore, the software systems are vulnerable to critical failures. For instance, an IT administrator may not apply a software update to keep the size of software small or to prevent breaking other features. Furthermore, not all fixes are equally critical to all users at a given instance of time.

### SUMMARY

In one illustrative embodiment, a method, in a data processing system, is provided for identifying criticality of a software fix. The method comprises obtaining a criticality description associated with a software fix of a software product deployed on the data processing system. The method further comprises determining, by the data processing system, a criticality value of the software fix based on computing environment of the data processing system and customer usage of the software product on the data processing system.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 is a block diagram of an example data processing system in which aspects of the illustrative embodiments may be implemented;

FIG. 3 is a block diagram illustrating a mechanism for allowing end users to assess the criticality of a software fix in accordance with an illustrative embodiment;

FIG. 4 is a flowchart illustrating operation of a server for allowing end users to assess the criticality of a software fix in accordance with an illustrative embodiment; and

FIG. 5 is a flowchart illustrating operation of a client for assessing the criticality of a software fix specific to a client deployment and usage of a software product in accordance with an illustrative embodiment.

### DETAILED DESCRIPTION

The illustrative embodiments provide a mechanism for allowing end users to assess the criticality of a software fix as it is relevant to that particular deployment. The illustrative embodiments provide a server side component and a client side component. In the server side component associated with the software provider, once a fix is created, the description of the fix and software assets that are impacted is published to a server accessible by the clients.

The client side component associated with a software user has a scheduled service in the product that checks for updates on the server. The service reviews the published information and compares what features/functionalities are impacted by the released fix. When a new fix is found on the server, the update service on the client downloads the description and lists software assets impacted. The client side component also has an analytics/monitoring component that records usage of the product and provides a criticality value for the fix as it applies to the client's current deployment and usage.

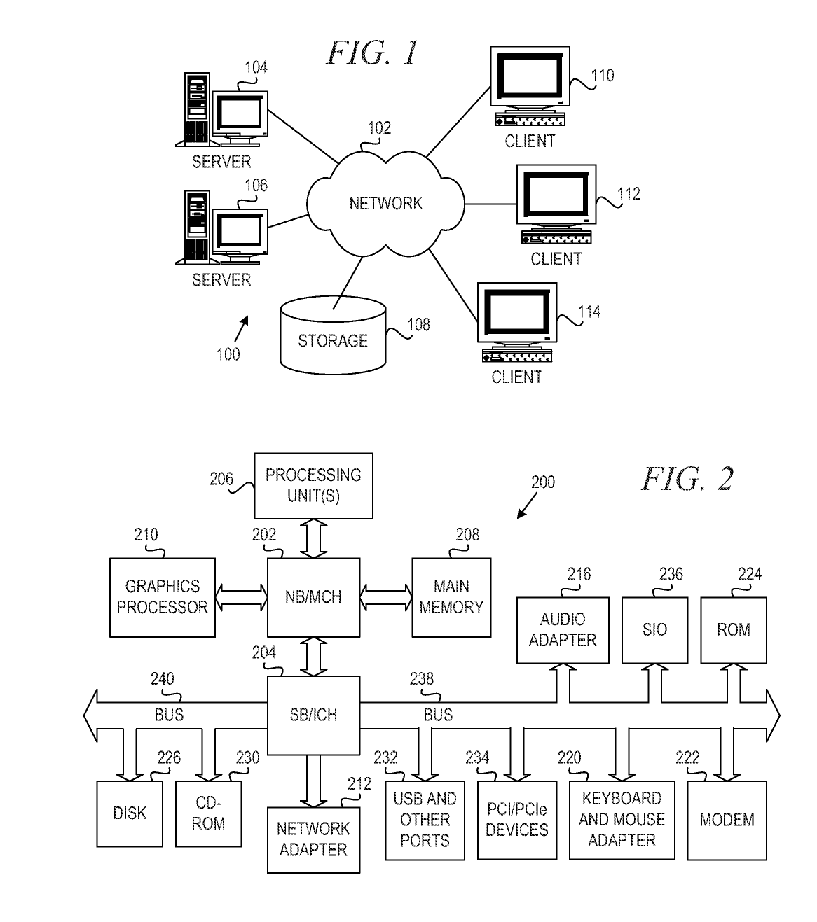

The illustrative embodiments may be utilized in many different types of data processing environments. In order to provide a context for the description of the specific elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example data processing system in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft Windows 7 (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Oracle and/or its affiliates).

As a server, data processing system 200 may be, for example, an IBM® eServer™ System P® computer system, running the Advanced Interactive Executive (AIX®) operating system or the LINUX operating system (IBM, eServer, System p, and AIX are trademarks of International Business Machines Corporation in the United States, other countries, or both, and LINUX is a registered trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

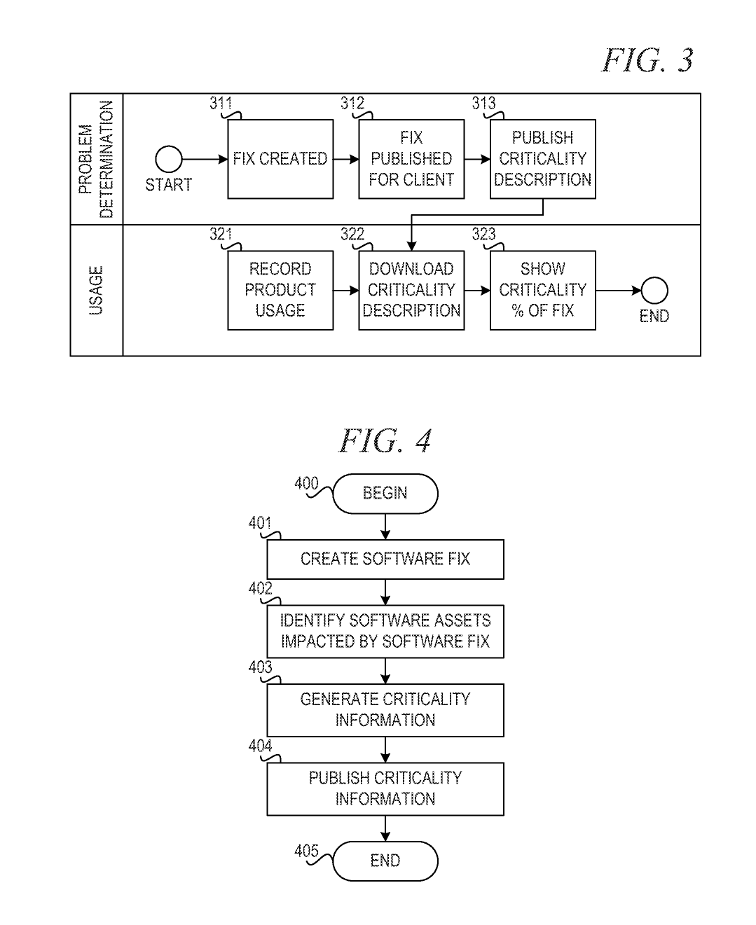

FIG. 3 is a block diagram illustrating a mechanism for allowing end users to assess the criticality of a software fix in accordance with an illustrative embodiment. The server side performs problem determination. The server side creates a software fix 311 and publishes the fix for the client 312. The server also publishes a criticality description for the software fix 313. The criticality description comprises information relating to criticality of the software fix. For example, this information may describe software assets, like Java™ archive (JAR) files, Java™ server page (JSP) files, etc., impacted by the software fix. The server publishes the criticality description to be accessible by the clients. The criticality description may be published as metadata associated with the software fix.

The client side records product usage 321. In response to a new software fix or a change in usage of the software product, the client side downloads the criticality description 322. The client side component matches the criticality description against the product's built-in analytics/monitoring capabilities that report on usage of the product. The client side component provides a criticality value for the software fix as it applies to the client's current deployment and usage 323. The client side component may determine the criticality value based on the criticality information and the product usage information. More particularly, the client side component may compare the software files and functions affected by the update to software files and functions that are in actual usage, as well as dependencies. The client side component may calculate the criticality such that an increased amount of usage of the affected functions, components, or files results in a higher criticality value.

In one example embodiment, the criticality value may be a percentage such that a low percentage indicates the software fix has low criticality and a high percentage indicates the software fix has high criticality. The client side component may compare the criticality value to a threshold and apply the software fix in response to the criticality value exceeding the threshold. On the other hand, the client side component may not apply the software fix if the criticality value is less than the threshold.

As an example, consider a case of user access security that has been turned off for a Web based Java™ product. The product usage monitoring capabilities will report that the login Java™ server page (JSP) file is not in use. If the product development team releases a fix pertaining to the login JSP file, then this fix is not very useful for this client. Therefore, the client side component determines and presents the criticality as low. However, if the client later decides to enable user access security and place the login page in front of the portal, then the criticality for the same fix will become high.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

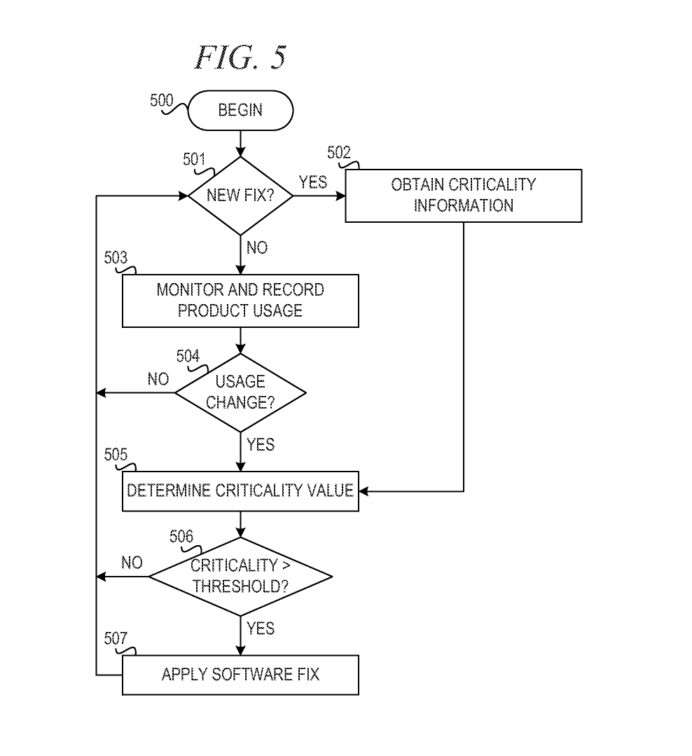

FIG. 4 is a flowchart illustrating operation of a server for allowing end users to assess the criticality of a software fix in accordance with an illustrative embodiment. Operation begins (block 400), and the software provider creates a software fix (block 401). A software provider or server side component identifies software assets and other computer assets impacted by the software fix (block 402). The server side component generates criticality information for the software fix (block 403), and publishes the criticality information (block 404). Thereafter, operation ends (block 405).

FIG. 5 is a flowchart illustrating operation of a client for assessing the criticality of a software fix specific to a client deployment and usage of a software product in accordance with an illustrative embodiment. Operation begins (block 500), and a client side component determines whether a new software fix for a software product on the client is published (block 501). Ifa new software fix is published, the client side component obtains the criticality information (block 502).

If a new software fix is not published in block 501, the client side component monitors and records product usage on the client (block 503). The client side component determines whether usage of the software product has changed (block 504). If usage of the software product has not changed, operation returns to bock 501 to determine whether a new software fix is published.

If the client side component detects a change in usage in block 504 or responsive to obtaining criticality information for a new software fix in block 502, the client side component determines a criticality value for the software fix based on the computing environment of the client data processing system and usage information of customer usage of the software product (block 505). The client side component then determines whether the criticality value is greater than a threshold (block 506). If the criticality value is not greater than the threshold, then operation returns to bock 501 to determine whether a new software fix is published.

If the criticality value is greater than the threshold in block 506, the client side component applies the software fix (block 507). Thereafter, operation returns to bock 501 to determine whether a new software fix is published.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, the illustrative embodiments provide mechanisms for allowing end users to assess the criticality of a software fix as it is relevant to that particular deployment. The illustrative embodiments determine the criticality of a software fix as it applies to a particular client. The mechanisms not only measure whether a patch or fix applies to a client but also identify the necessity or criticality of the fix. As a result, the illustrative embodiments provide a list of truly recommended fixes based on customer environment as opposed to general recommendations.

In the illustrative embodiments, the server does not gather support usage information, but rather simply pushes the description of the fix to the clients or publishes the description to be downloaded by the clients. The comparison that determines the criticality of the fix is done by the clients and not the server. This approach helps both privacy and performance. The client data does not leave the client's environment, and there is no processing and data storage of all the clients on the support server side.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for identifying criticality of a software fix, the method comprising:
obtaining a criticality description associated with a software fix of a software product deployed on the data processing system; and
determining, by the data processing system, a criticality value of the software fix based on computing environment of the data processing system and customer usage of the software product on the data processing system.

2. The method of claim 1, further comprising:
determining whether to apply the software fix to the software product on the data processing system based on the criticality value.

3. The method of claim 2, wherein determining whether to apply the software fix comprises:
comparing the criticality value to a threshold; and
responsive to the criticality value being greater than the threshold, applying the software fix.

4. The method of claim 1, further comprising:
monitoring and recording customer usage of the software product on the data processing system.

5. The method of claim 4, further comprising:
responsive to determining customer usage of the software product has changed, determining a new criticality value of the software fix based on the computing environment of the data processing system and the customer usage of the software product.

6. The method of claim 5, further comprising:
determining whether to apply the software fix to the software product on the data processing system based on the new criticality value.

7. The method of claim 1, wherein obtaining the criticality description associated with the software fix comprises obtaining the criticality description from metadata associated with the software fix.

8. A computer program product comprising a computer readable storage medium having a computer readable program stored therein, wherein the computer readable program, when executed on a computing device, causes the computing device to:
obtain a criticality description associated with a software fix of a software product deployed on the computing device; and
determine, by the computing device, a criticality value of the software fix based on computing environment of the computing device and customer usage of the software product on the computing device.

9. The computer program product of claim 8, wherein the computer readable program further causes the computing device to:
determine whether to apply the software fix to the software product on the computing device based on the criticality value.

10. The computer program product of claim 9, wherein determining whether to apply the software fix comprises:
comparing the criticality value to a threshold; and
responsive to the criticality value being greater than the threshold, applying the software fix.

11. The computer program product of claim 8, wherein the computer readable program further causes the computing device to:
monitor and record customer usage of the software product on the computing device.

12. The computer program product of claim 11, wherein the computer readable program further causes the computing device to:
responsive to determining customer usage of the software product has changed, determine a new criticality value of the software fix based on the computing environment of the computing device and the customer usage of the software product.

13. The computer program product of claim 12, wherein the computer readable program further causes the computing device to:
determine whether to apply the software fix to the software product on the computing device based on the new criticality value.

14. The computer program product of claim 8, wherein obtaining the criticality description associated with the software fix comprises obtaining the criticality description from metadata associated with the software fix.

15. The computer program product of claim 8, wherein the computer readable program is stored in a computer readable storage medium in a data processing system and wherein the computer readable program was downloaded over a network from a remote data processing system.

16. The computer program product of claim 8, wherein the computer readable program is stored in a computer readable storage medium in a server data processing system and wherein the computer readable program is downloaded over a network to a remote data processing system for use in a computer readable storage medium with the remote system.

17. An apparatus, comprising:
a processor; and
a memory coupled to the processor, wherein the memory comprises instructions which, when executed by the processor, cause the processor to:
obtain a criticality description associated with a software fix of a software product deployed on a data processing system; and
determine, by the computing device, a criticality value of the software fix based on computing environment of the data processing system and customer usage of the software product on the data processing system.

18. The apparatus of claim 17, wherein determining whether to apply the software fix comprises:
comparing the criticality value to a threshold; and
responsive to the criticality value being greater than the threshold, applying the software fix.

19. The apparatus of claim 17, wherein the instructions further cause the processor to:
monitor and record customer usage of the software product on the computing device;
responsive to determining customer usage of the software product has changed, determine a new criticality value of the software fix based on the computing environment of the data processing system and the customer usage of the software product; and
determine whether to apply the software fix to the software product on the data processing system based on the new criticality value.

20. The apparatus of claim 17, wherein obtaining the criticality description associated with the software fix comprises obtaining the criticality description from metadata associated with the software fix.
